(19) United States
(12) Patent Application Publication
(10) Pub. No.: US 2010/0123003 A1
(43) Pub. Date: May 20, 2010

(54) METHOD FOR VERIFYING INSTANT CARD ISSUANCE

(76) Inventors: A. Wayne Olson, Las Vegas, NV (US); Gunther Gossmann, Las Vegas, NV (US)

Correspondence Address: STETINA BRUNDA GARRED & BRUCKER, 75 ENTERPRISE, SUITE 250, ALISO VIEJO, CA, 92656, US

(21) Appl. No.: 12/274,732

(22) Filed: Nov. 20, 2008

(51) Int. Cl. G06F 19/00

(52) U.S. Cl. 235/380

(57) ABSTRACT

There is disclosed a method for verifying instant card issuance. The method begins with receiving from a user an identification credential including personally identifying data. Then the method continues with authenticating the user based upon an evaluation of the personally identifying data against a fraud detection database. The identity of the user may be correlated to the identity specified in the identification credential. The user is then validated based upon an analysis of the personally identifying data against a compliance database including a list of prohibited identities or watch lists. The user is designated as authorized upon proper authentication and validation. The method concludes with dispensing a transaction card linked via a unique identifier to a financial account associated with the authorized user. The transaction card is imprinted with the unique identifier and a custom user-selected design.

### CROSS-REFERENCE TO RELATED APPLICATIONS

The present application relates to the concurrently filed co-pending application entitled “CARD PRINTING VERIFICATION SYSTEM,” the disclosure of which is expressly incorporated by reference in its entirety herein.

### STATEMENT RE: FEDERALLY SPONSORED RESEARCH/DEVELOPMENT

Not Applicable

### BACKGROUND

1. Technical Field

The present invention relates generally to automated financial transaction methods, and more particularly, to methods for verifying and authenticating the identity of users of payment cards at issuance.

2. Related Art

Fundamental to the functioning of commerce is the exchange of payment for goods and services, which is conducted with standardized currency. Currency serves as a medium of exchange, a store of value, and a delivery of value, and is minted and controlled by a central bank of a country. In earlier times, heavy metallic coins served as currency, but due to its weight and general inconvenience, however, especially for the payment of large sums of money, paper currency or banknotes gradually supplanted coins.

For much of the same reasons, traditional paper currency is becoming less utilized. While being fundamentally based on the value of paper currency, modern financial transactions involve the electronic transfer of funds, otherwise referred to as “cashless” transactions that do not involve the physical exchange of paper currency. Cashless transactions are fast and convenient, especially for online shopping where the buyer and the seller may be on opposite ends of the country, or even of the world. The payment can be verified instantaneously, and the goods or services can be delivered shortly thereafter.

Credit cards and its associated infrastructure is one form of a cashless transaction system. Retail stores initially issued credit cards for use solely within that store or chain of stores, and the store extended credit to a customer to purchase items over time. Instead of being limited to just one company, contemporary credit cards may be used with many different merchants who are part of the credit card processing network such as VISA and MASTERCARD. A bank typically creates a new credit account and issues the card that is linked thereto. When the customer makes a purchase from an approved member merchant, the credit account number and the amount of the purchase, along with other relevant information, are transmitted via the processing network to authorize the transaction. The customer repays the debt, typically on a monthly basis after the end of a billing cycle. For the merchant, however, once the transaction is authorized, the linked bank account of the merchant is credited with the amount of the transaction.

Presently, because credit cards by definition extend credit to customers and so involves some degree of risk to the bank, creditworthiness and fraud prevention checks are performed prior to issuance. A prospective customer typically fills out an application form, which can be completed electronically through a website, if desired, and the supplied information is verified by the issuing bank. Once authorized, a card is printed with the corresponding card account number and mailed to the customer. Some banks allow the customer to select a background design reflective of the customer's personality or interest. Even if the customer is an existing one such that the established creditworthiness and trust can be inherited to the new account, there remains a substantial delay before the credit card is in the possession of the customer. This delay is exacerbated where credit checks and other authorization functions must be performed before issuing the card. Once the credit card arrives, there is yet another step involved; the customer must activate the card by calling the credit card company and answering a few security questions.

Debit cards are also commonly utilized for cashless transactions. The debit cards are linked to what is typically the customer's existing deposit account at a bank, such as a checking account or a savings account. Thus, a transaction cannot be completed unless there are sufficient funds in the customer's account. Similar to credit card processing, debit cards require transaction authorization over a processing network. In addition to transmitting the debit card number to the processing center, however, completing the transaction may require the user to enter a Personal Identification Number (PIN) into a terminal at the point of sale. Alternatively, the debit card transaction may be processed in the same manner as the credit card, but the linked deposit card will be deducted immediately.

Issuing debit cards to the customer is likewise a time-consuming process, because a new deposit account must be set up with the bank in a substantially similar way as setting up a new credit card account. Although the creditworthiness requirement may not be as stringent as with a credit card, a new customer must have sufficient funds to be deposited into the deposit account. Furthermore, the issuance of debit cards is typically no different than a credit card. A new debit card is requested only after establishing the deposit account so that the account number may be imprinted thereon, and there remains a substantial delay before the debit card is in the possession of the customer.

In addition to credit and debit cards, cashless transaction modalities also known in the art are prepaid cards. The customer purchases the card for a particular amount of money, and the cash-equivalent value associated therewith may be used to make other purchases. The cash-equivalent value may be stored directly on a memory of the card, or it may be stored on a remote database accessed with account information stored on a memory of the card. When the consumer uses the prepaid card to make a purchase, the data indicating the currently stored value is decreased by the amount of the purchase.

The most common use of this cashless transaction system is in relation to gift cards, such that a recipient may purchase anything desired within the limits of the gifted value. Prepaid cards are often issued by particular merchants, such that the cards can be used only when purchasing goods or services from that particular merchant. However, general use prepaid cards are common; such cards are useful when a gift giver is uncertain as to what the recipient desires, or even the store at which the recipient prefers to shop. The cards are typically available in preset denominations, and may or may not be activated before they are sold. Aside from the initial activation and payment/replenishment, there is very little customer involvement unlike credit and debit cards. Additionally, the cards are immediately available for use. Notwithstanding these advantages over credit and debit cards, prepaid cards have limited customization options, i.e., being limited to a select number of relatively low denominations, being limited to pre-printed cards as produced by the vendor of the same, and so forth.

Prepaid cards are also difficult to assert control over the transfer of funds stored thereon. This is particularly problematic since government regulations and enacted laws such as the Bank Secrecy Act, the Money Laundering Control Act, the USA-PATRIOT Act, require banks to monitor customer transactions and behaviors in order to report any suspicious activity that may be indicative of money laundering or other fraud such as identity theft. Moreover, in light of the heightened security requirements for protecting against terrorist attacks, banks must not permit monetary transfers to take place with any suspected terrorists. Reducing the availability with the goal of altogether eliminating the financial means for carrying out terrorist attacks serves a vital part in maintaining the security of the nation, as even very limited funding may be enough to launch a devastating attack with significant casualties. In this regard, prepaid cards may aid in the anonymous transfer of funds to such terrorist groups. Although not as susceptible to such uses, credit cards and debit cards may likewise be used for terrorist financing, particularly where the cards are issued without the proper background checks. Prohibitions on transactions further extend to other objectionable individuals such as drug traffickers, members of organized crime, corrupt officials and businesspeople, and the like.

Accordingly, there is a need in the art for a method for verifying instant card issuance, and it is to such needs, among others, that the present invention is directed.

### BRIEF SUMMARY

According to one embodiment of the present invention, there is provided a method for verifying instant card issuance. The method begins with receiving from a user an identification credential including personally identifying data. Then the method continues with authenticating the user based upon an evaluation of the personally identifying data against a fraud detection database, The identity of the user may be correlated to the identity specified in the identification credential. The user is validated based upon an analysis of the personally identifying data against a compliance database including a list of prohibited identities. The user may be designated as authorized upon proper authentication and validation. The method may conclude with dispensing a transaction card linked via a unique identifier to a financial account associated with the authorized user. The transaction card may be imprinted with the unique identifier and a custom user-selected design.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram of a card printing verification system in accordance with one embodiment of the present invention;

FIG. 2 is a diagram of the hardware associated with a client side component and a server side component of the card printing verification system;

FIG. 3 is a flowchart showing the overview of steps in a method for verifying instant card issuance in accordance with another embodiment of the present invention;

FIG. 4 is a diagram illustrating the components of a Permanent Account Number;

FIG. 5 is a plan view of an exemplary customer card including a magnetic strip and various identifying numbers imprinted thereon;

FIG. 6a is a flowchart illustrating a first group of steps for issuing a new card that utilizes the method for verifying instant card issuance;

FIG. 6b is a flowchart detailing a second group of steps for issuing a new card continued from the first group of steps shown in FIG. 6a as well as a second group of steps for reissuing a new card continued from the first group of steps shown in FIG. 6c;

FIG. 6c is a flowchart detailing a first group of steps for reissuing a new card to an existing user that utilizes the method for verifying instant card issuance according to one embodiment of the present invention;

FIG. 6d is a flowchart describing the steps for loading additional currency into the card;

FIG. 6e is a flowchart describing the steps for checking the balance of the card; and

FIG. 6f is a flowchart detailing the steps for transferring currency in accordance with one embodiment of the present invention.

Common reference numerals are used throughout the drawings and the detailed description to indicate the same elements.

### DETAILED DESCRIPTION

The detailed description set forth below in connection with the appended drawings is intended as a description of the presently preferred embodiment of the invention, and is not intended to represent the only form in which the present invention may be developed or utilized. The description sets forth the functions of the invention in connection with the illustrated embodiment. It is to be understood, however, that the same or equivalent functions may be accomplished by different embodiments that are also intended to be encompassed within the scope of the invention. It is further understood that the use of relational terms such as first and second and the like are used solely to distinguish one from another entity without necessarily requiring or implying any actual such relationship or order between such entities. The present application relates to the concurrently filed co-pending application entitled “CARD PRINTING VERIFICATION SYSTEM,” the disclosure of which is expressly incorporated by reference in its entirety herein.

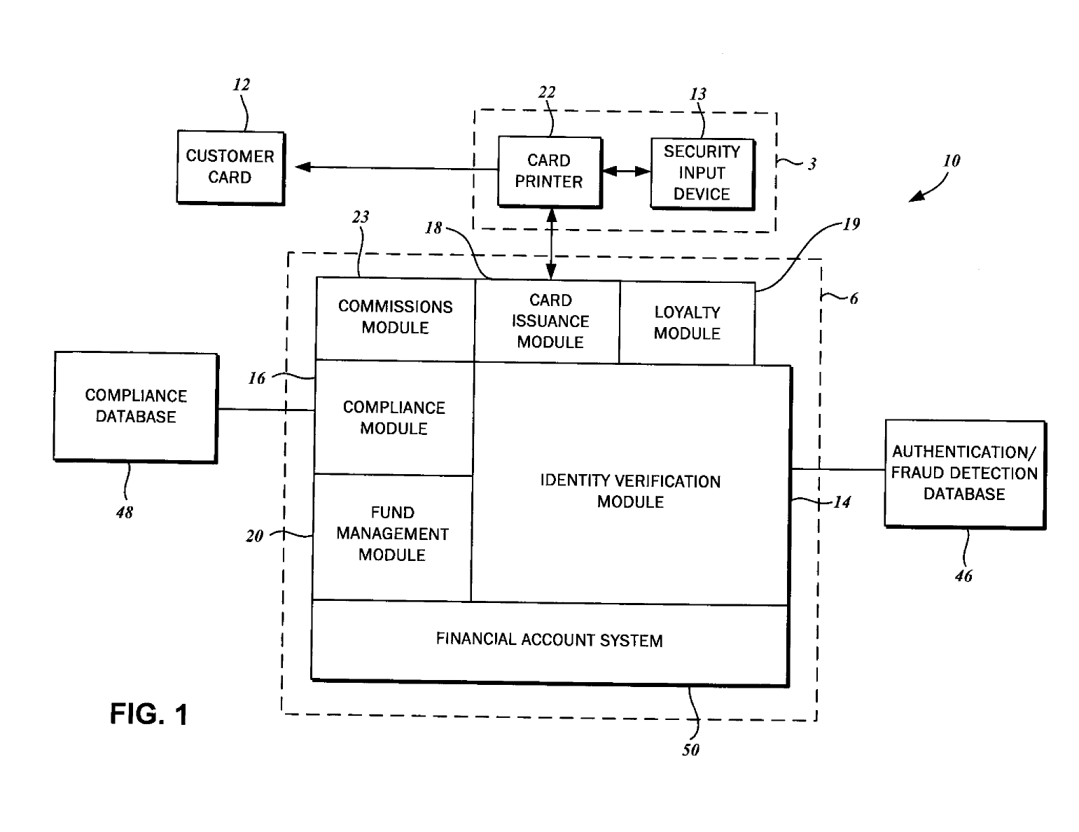

With reference to the block diagram of FIG. 1, various components of a card printing verification system 10 according to one embodiment of the present invention are illustrated. It is generally envisioned that the card printing verification system 10 is configured to issue a personalized customer card 12 that can be utilized as a payment method with various merchants immediately upon issuance, i.e., the card 12 is activated when dispensed to a customer. As will be described in further detail below, the card printing verification system 10 includes a security input device 13, an identity verification module 14, a compliance module 16, a card issuance module 18, a loyalty module 19, a fund management module 20, a commissions module 23, and a card printer 22. The security input device 13 and the card printer 22 are understood to be client side components 3, while the identity verification module 14, the compliance module 16, the card issuance module 18, and the fund management module are server components 6. In this regard, the client side components 3 are remotely located with respect to the server side components. It is further contemplated that the personalization of the card is on demand and is directed by the customer, and the extent of personalization possible, among other operating parameters, is established by a system administrator who also manages the overall functioning of the card printing verification system 10.

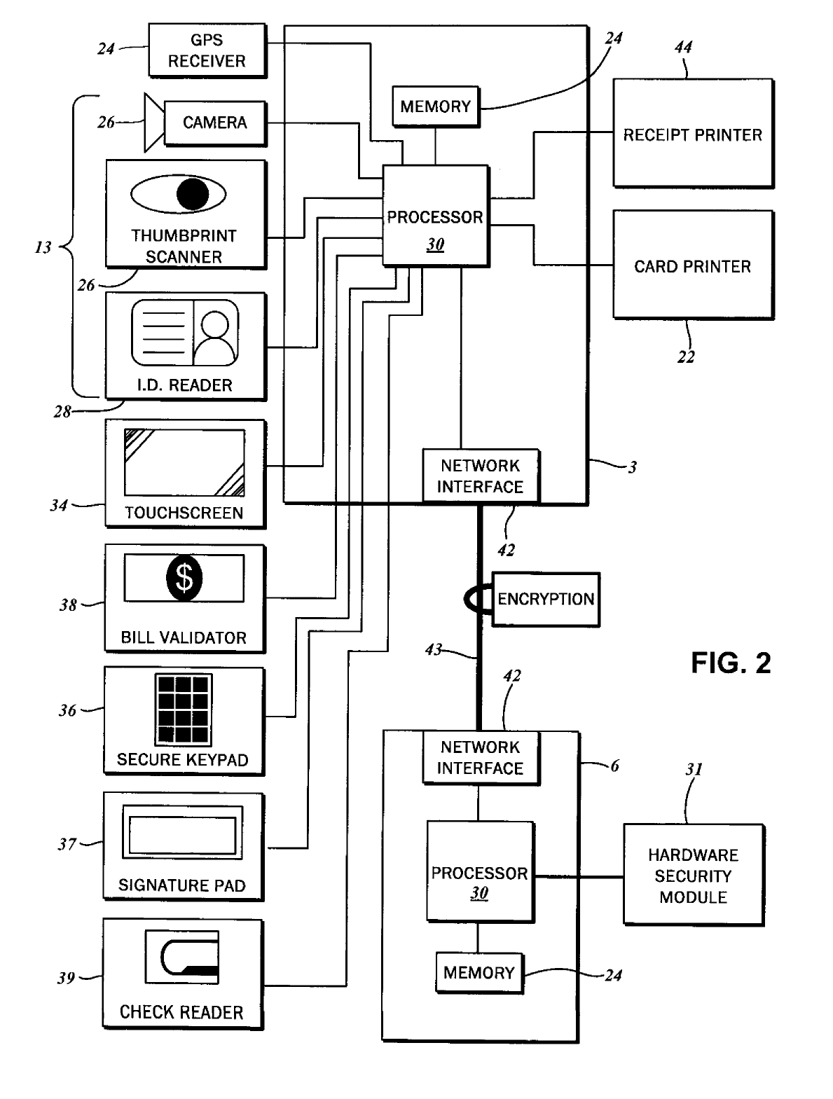

FIG. 2 best illustrates the components of the client side component 3 of the card printing verification system 10 as embodied in hardware. The security input device 13 is understood to refer variously to a security camera 24, a thumbprint scanner 26, and an identification (ID) card reader 28. The various uses for the security input devices 13 in the context of the card printing verification system 10 will become more apparent in view of the various functionalities for which they are used; those having ordinary skill in the art will recognize that the hardware implementations of the security input devices 13 may be any conventional or future variation thereof, and any such variation may be readily substituted without departing from the scope of the present invention. For example, the security camera 24 may have a conventional charge coupled device (CCD) sensor or a CMOS sensor and captures digital images for electronic storage. Alternatively, the security camera 24 may record a continuous video signal, with selected frames therefrom being represented as image captures. Further, thumbprint scanner 26 is presented by way of example only and not of limitation, and other biometric readers such as retina scanners and the like may also be utilized. With respect to the ID card reader 28, it will be appreciated that most common government-issued identification cards have magnetic strips and/or secure barcodes. A variety of information is encoded on such magnetic strips or barcodes that correspond to the printed information on the face of the card. Additional details relating to the magnetic strip will be discussed further below because one embodiment of the present invention contemplates such strips to be on the customer card 12 as well. For purposes of discussing the ID card reader 28, sufficient description thereof is given as a magnetic reader capable of decoding the information on the magnetic strip, and in embodiments that utilize barcodes, a laser barcode reader. It will be appreciated that instead of magnetic strips, some advanced identification cards known in the art as “smart cards” utilize an integrated circuit data storage and/or processing device embedded therein. In this regard, it is to be understood that the ID card reader 28 is operative to read stored data from such integrated circuit data storage devices and otherwise communicate with the processing subcomponents thereof to the extent there are any.

Each of the above-described security input devices 13 are controlled by and send data to a central processor 30. In further detail, it is understood that the central processor 30 utilizes an internal memory device 32 for various data storage functions. The memory device 32 may be a conventional Random Access Memory (RAM), a Flash memory device, or magnetic recording devices such as hard drives and tapes. Stored on the memory device 32 are instructions in the form of software that, when executed, performs some of the steps or features of the present invention. With further particularity regarding the processor 30, it will be appreciated by one of ordinary skill in the art that any suitable data processing device conforming to any one of well-known architectures may be utilized. Because the processing of images, video, analyzing thumbprints, and other related functions described below are processor-intensive, a suitably powerful device is used. In order to provide an interactive environment allowing the customer to supply various data and specify the customization of the customer card 12, the card printing verification system in accordance with one embodiment of the present invention includes a touch screen device 34.

As indicated above, the central processor 30 generates an output based upon certain data processing operations that is directed to the touch screen device 34. Relatedly, any inputs detected by the sensor of the touch screen device 34 are directed to the central processor 30 for processing. There are a number of different technologies relating to touch screen devices, and any given one may be substituted for another. While conventional touch screen devices can be constructed durably, there may be some instances where it is undesirable; for such instances, other embodiments of the interface involving the placement of various navigation keys in the vicinity of the screen are also contemplated.

In addition to the touch screen device 34, the hardware embodying the client side component 3 of the card printing verification system 10 includes a secure keypad 36. Although any variety of keypad may be utilized, the illustrated embodiment is a standard 12-key numeric keypad having keys 0-9, a pound sign (#) and a star sign (*). Therefore, short sequences of numbers and alphabetic characters may be inputted. In further detail, the secure keypad 36 is understood to include encryption facilities to prevent eavesdropping between the keypad itself and the processor 30. One common encryption methodology is the Triple Data Encryption Standard (DES), and there are numerous others known in the art. Compliance with security standards require such encryption for input data.

The hardware of the client side component 3 also includes a signature pad 37 for capturing signatures from customers for incorporation into the customer card 12. It is understood that the signature pad 37 is a conventional pen-and-tablet device that digitizes the strokes as inputted via the pen. A number of various technologies are known in the art, including passive tablets, active tablets, optical tablets, and capacitive tablets, among others, and it will be appreciated by those having ordinary skill in the art that any such technology may be readily substituted. According to one embodiment, the signature pad 37 is a KioskGem Model T-S261-K from Topaz Systems, Inc. of Simi Valley, Calif. Further details of use in relation to the card printing verification system 10 will be described below.

Briefly, one embodiment of the present invention contemplates the card printing verification system 10 issuing the customer card 12 with a monetary value pre-assigned thereto, which is based on cash received at the time of issuance. For such embodiments, the client-side component 3 is provided with a bill validator 38 that physically retrieves a partially inserted bill, scans the bill to confirm that it is not counterfeit, and ascertains its value. Thereafter, the bill is conveyed to a storage area, and the value is signaled to the central processor 30. In addition to cash, however, it is also contemplated that the pre-assigned monetary value be based upon an amount indicated on a check. Thus, payroll checks and the like can be deposited into the account of the customer card 12. The client-side component 3 further includes a check reader 39 that scans the image of the front and the back side of a check for transmission thereof to a check verification/guaranty processor. Any one of well-known check readers 39 presently available may be utilized: one of which is model number SB50E by CTS North America of Burlington, Mass.; and another being model RS890/891 by Ernst Reiner GmbH & Co KG of Furtwangen, Germany.

Another miscellaneous hardware device that may be included in the card printing verification system 10 is a GPS receiver 40. As is well known, the GPS receiver 40 receives signals from multiple GPS satellites orbiting the Earth. Based upon a calculation involving relative signal receipt speeds, exact position coordinates can be ascertained. Because the client side component 3 of the card printing verification system 10 may be numerously deployed across wide geographic areas, maintenance may be cumbersome without a modality such as the GPS receiver 40. The present invention contemplates the use of a position indicator for such tracking needs, and the UPS receiver 40 is understood to be one such indicator. While a GPS receiver, when left on, continuously updates its calculated position coordinates, for power consumption or processor load reasons, the GPS receiver 40 may be turned on only when the data therefrom is required, notwithstanding the potential delay in acquiring satellite lock.

Along these lines, it is also contemplated that the client-side component 3 transmits to and receives data from the server-side component 6. In order to enable such communications, there is provided a network interface 42, which may implement a connection to the Internet (Transmission Control Protocol/Internet Protocol, or TCP/IP), a dial-up connection, a Virtual Private Network (VPN), a Frame relay network, a wireless mobile network such as GSM, EDGE, and the like, or any other suitable data communications network 43. As utilized herein, reference to a network is understood to encompass all such network types. With further particularity, in order to ensure security, all traffic on the data communications network 43 is encrypted. In this regard, it is understood that the network interface 42 on both the client-side component 3 and the server-side component 6 implement the encryption methodologies.

Upon the completion of each transaction, as is common to many financial transaction systems, a paper record thereof is produced by a receipt printer 44. Conventional receipt printers typically utilize thermal transfer roll paper, though the present invention does not depend on any particular type of imprinting modalities.

All of the aforementioned hardware devices are housed within a tamper-proof enclosure, access to which may be limited by lock devices. It is understood, however, that the devices that interface with customer, such as the touch screen 34 or the secure keypad 36, at least the operative portions are exposed and outside the enclosure. The enclosure may be variously designed for increased weather and tamper resistance, as well as aesthetics. Along these lines, the client-side component 3 of the card printing verification system 10 may be provided with signage and labels that clearly identifies its functionality.

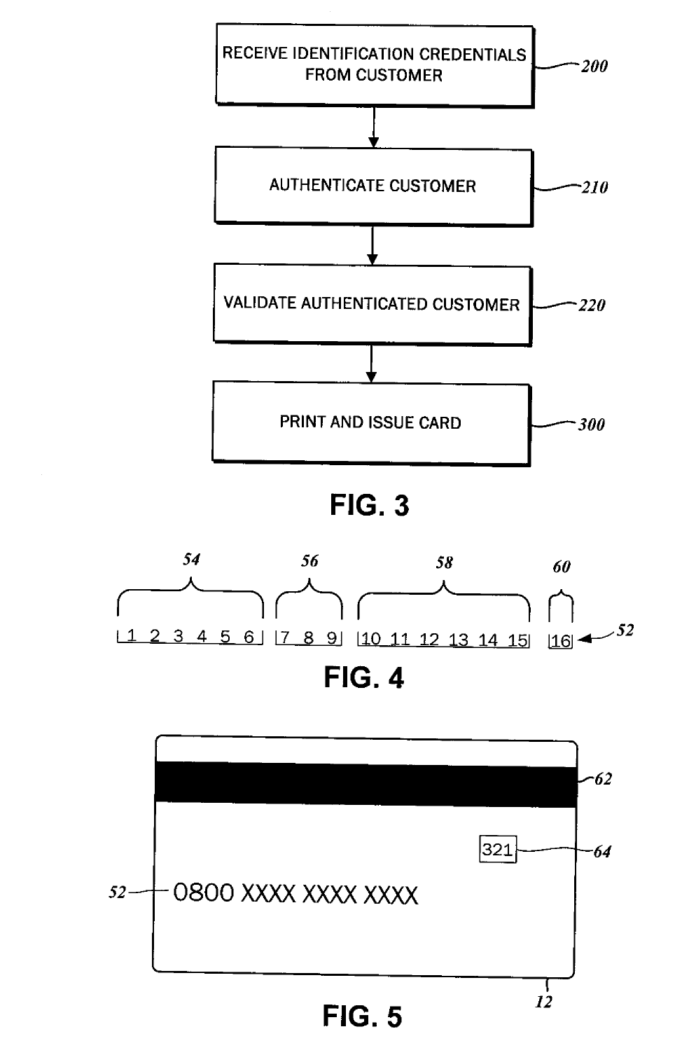

As also shown in the block diagram of FIG. 3, the hardware embodiment of the server-side component 6 likewise includes the processor 30, a memory 32, and a network interface 42. The server-side component 6 of the card printing verification system 10 communicates over the network interface with the client side component 3. Additionally, the server side component 6 includes an external hardware security module (HSM) 31 that is used to verify, create, and encrypt Personal Identification Numbers (PIN) of the customer cards 12. The HSM 31 is understood to provide logical and physical protection of such sensitive data from unauthorized use by isolating security functions from the rest of the server 6.

Referring now to the flowchart of FIG. 3, in accordance with another aspect of the present invention, the card printing verification system 10 may embody a method for verifying instant card issuance. Broadly, the method begins with a step 200 of receiving an identification credential from the customer. As utilized herein, the term identification credential is understood to refer to any of the aforementioned user-specific records such as ID Cards, thumbprints, and so forth. Such user-specific records by definition include personally identifying data such as name, residence address, age, etc. With respect to thumbprints and other biometric data, it is understood that almost every person on the planet can be uniquely identified thereby, if not with near certainty, then with a great degree of accuracy. It is contemplated that more than one identification “factor” may be received to improve correlation accuracy. For example, the information read from the ID card may be compared against the identity corresponding to the thumbprint, thus reducing the incidence of identity theft and fraud resulting from a loss of an easily misplaced credential such as an ID card. As explained above, the client-side component 3 of the card printing verification system 10 includes the security input device 13 for receiving the identification credential.

Also referring to FIG. 1, the method then continues with a step 210 of authenticating the customer based upon an evaluation of the personally identifying data against a remote fraud detection database 46. Under this step, the identity of the customer is correlated to the identity specified in the identification credentials. The server-side component 6 of the card printing verification system 10 according to one embodiment of the present invention includes the identity verification module 14 that is in communication with the security input device 13, and receives the personally identifying data therefrom. It is contemplated that the identity verification module 14 can communicate with a third party verification solution such as Bridger Insight XG from ChoicePoint. Generally, it is understood that such third party verification solutions have access to a vast database of user identities, and the supplied personally identifying data is compared thereto. There are other functions performed, such as the confirmation of the true owner of a Social Security Number (SSN), detection of potential identity theft and synthetic identities, and detection of repeat fraudsters.

After authenticating the customer, i.e, ascertaining that the customer is, indeed, who he purports to be, the method continues with a step 220 of validating such authenticated customer upon a positive evaluation of the personally identifying data against a compliance database 48. In this context, a positive evaluation is understood to refer to a condition where there are no matches between the authenticated customer and any identities in the compliance database 48. As indicated above, the server-side component 6 of the card printing verification system 10 includes the compliance module 16 that is communicatively linked to the compliance database 48. The compliance database 48 is understood to contain a list of prohibited individuals with whom the customer is prohibited from transacting, and ensures that each customer, account, and transaction comply with, for example among many others, the Money Service Business rules as promulgated by the United States Department of the Treasury. Additional compliance with regulations such as the Anti-Money Laundering Regulations of the Office of Foreign Assets Control (OFAC) of the United States Department of the Treasury, and statutes such as the USA Patriot Act and the Bank Secrecy Act are likewise contemplated. Policies suggested by the Office of the Comptroller of the Currency (OCC) and the Financial Crimes Enforcement Network (FinCEN) are also intended to be adhered to. By way of example only and not of limitation, in the United States, the compliance database 48 may be the OFAC Specially Designated Nationals List, the FBI Most Wanted list; in Canada, the Office of the Superintendent of Financial Institutions List of Names Subject to Terrorist Suppression Regulations; in the United Kingdom, the Bank of England Consolidated List; in the European Union, the European Union Consolidated List; and in France, the Financial Action Task Force List of Non-Cooperative Countries. Additionally, the compliance database 48 may be the United Nations Consolidated List. Any one or a combination of any of the foregoing databases may be queried by the compliance module 16, and it is to be understood that such databases are presented by way of example only and not of limitation. Any other like prohibited persons, entities, or nationalities list may be readily substituted without departing from the scope of the present invention.

Because compliance with the foregoing prohibited persons regulations is so closely related to compliance with regulations for detecting and reporting money laundering activities, it is contemplated that the compliance module 16 detects and logs it. All manner of transactions are tracked by country, by velocity (how often each transaction is conducted by a given customer), by distribution, by recipient, and by usage. According to one embodiment of the present invention, reports regarding suspicious transactions are generated in accordance with the United States Department of Treasury mandates.

Tracking and logging of all transactions passing through the server component 6 of the card printing verification system also serves an accounting function for revenue sharing. In one aspect of the present invention, a commissions module 23 manages the distribution of the fees between the different entities that are involved in each transaction. A distribution table for each virtual account, card, product, or service is defined, and the values thereof are incremented.

Along these lines, a loyalty module 19 also tracks customer usage by assigning points or other such units after each transaction. Furthermore, certain types of transactions (such as those more profitable) may be assigned higher point values to encourage the same. Upon accumulation of a threshold number of points, the customer 12 may exchange the points for merchandize or special promotions.

It is contemplated that the identity compliance module 16 can communicate with a third party compliance solution such as Bridger Insight XG from ChoicePoint or ISWATCH from Intelligent Search Technology, Ltd.

With reference again to FIG. 1, the server-side component 6 of the card printing verification system 10 includes the fund management module 20, with the various functions thereof being accessible by the customer upon authentication and validation in accordance with the foregoing steps. More particularly, the fund management module 20 is linked to a financial account system 50. The financial account system 50 has separate accounts that are each associated with a particular customer, and in its most basic embodiment, denotes the amount of funds therein and a unique account identifier. According to one embodiment, this separate account is referred to as a virtual account. As will be explained with greater particularity below, the virtual account is accessible by any one of numerous means. The fund management module 20 is operative to modify the value corresponding to the amount of available funds based on withdrawals from and deposits into the virtual account. In addition to modifying existing virtual accounts, the fund management module 20 is operative to create new virtual accounts as requested by the customer. Importantly, the fund management module 20 performs additional validations, such as ensuring the account identifier is correct, ensuring that the PIN is valid and correct, ensuring that there are sufficient funds in the virtual account to make a purchase, withdrawal, or transfer. Further, the fund management module 20 ensures that the funds being transferred into the virtual account are valid.

Preferably, though optionally, the financial account system 50 is of the escrow type. Various sub-escrow accounts are contemplated, including direct deposit accounts where customer funds are deposited until a request to use it is received and validated. Another contemplated sub-escrow account is of a stored value type. In this account, a customer can move funds from the direct deposit account into the stored value escrow account and vice versa. The stored value card can be used with conventional points of sale of credit card processing networks. The amount of money in the stored value card is guaranteed by an authoritative organization that controls the operation of the account system 50. Yet another type of a sub-escrow account envisioned for use in conjunction with the financial account system 50 is a mobile account, which associates a mobile phone number with a deposit account that can be used to make purchases through the mobile phone. Further, another sub-escrow account that may be utilized is a set-aside account, where customer funds are placed therein until confirmation of completion of the other part of the transaction.

As indicated above, each virtual account is identified by a unique number. With reference to the diagram of FIG. 4, the unique number is also referred to as a permanent account number (PAN) 52. The first six digits are referred to as the Issuer Identification Number (IIN) 54, which is used to identify an issuer and improve management of card transactions, authorizations, and settlements. The next two digits are referred to as the Sub-IIN 56, which identifies products, services, and geographic locations. Digits ten through fifteen comprise a customer account number 58, which identifies individual cardholders. Digit sixteen is a check digit 60, which is a checksum of the other numbers in the PAN 52 that determines validity. The structure of the PAN permits account management at multiple hierarchies.

After authenticating and validating the customer, the method in accordance with one embodiment of the present invention involves a step 300 of issuing the card. More particularly, the above-described card issuance module 18 generates the PAN 52 and ties it with the new account. It is understood that the card issuance module 18 can be a separate application, such as CardWizard from Dynamic Card solutions. A personal identification number (PIN) is assigned to the new account, the entry of which is necessary to permit future access. All major PIN calculations include Left/Right, Key Party, and ZCMK may be utilized. Furthermore, a security verification code 64 may be generated from the expiration date and the PAN 52, and similarly assigned to the new account. It is understood that any conventional verification code algorithm may be used, including CVV, CVC, CVV2, and CVC2.

It will be recognized by those having ordinary skill in the art that while the encoding of various data on to the card 12 has been described in the context of the exemplary financial account system 50 that utilizes escrow accounts, the card printing verification system 10 in accordance with the present invention may be utilized for other types of cards. For example, credit cards, debit cards, prepaid debit cards, member cards, gift cards, retailer loyalty cards, and the like may all be immediately issued while maintaining security and compliance. In this regard, the client-side component 3 may be attachable to existing automated teller machines (ATMs), deployed as custom card dispensing stations.

Referring to a more detailed view of the customer card 12 shown in FIG. 5, as briefly mentioned above, one embodiment of the customer card 12 utilizes a magnetic strip 62 for storing encoded data such as that described above, including the PAN 52, the security verification code 64, and so forth. In further detail, the magnetic strip may be on one track, but the use of additional tracks is also possible. As indicated above, in addition to the magnetic strip 62, the customer card 12 may include barcodes such as a two-dimensional matrix symbol. It is also possible to utilize “smart cards,” i.e., cards with integrated circuit memory and processing devices embedded within the body of the card 12.

Prior to dispensing the card 12 to the customer, the customer may personalize it in a variety of ways. According to another aspect of the present invention, various background images may be viewed and selected for application to both the front face and the back face of the card 12. After making an initial selection, a preview of the background as printed may also displayed before final printing. Customization options that are available may include college themed backgrounds, sports-themed background, nature-themed backgrounds, and so forth.

Serving also as a security measure in addition to customization, the camera 24 may take one or more pictures of the customer to print on to the card 12. More particularly, the camera 24 may take up to six pictures, and display each of the six on the touch screen user interface 34. The customer may then select a desired one that appears the best.

The card printer 22 is understood to have the capabilities of placing the aforementioned graphics and pictures onto the card 12, as well as encoding the relevant data onto the magnetic strip 62. As the card printer 22 can print various graphics on to the card 12, it will be appreciated that the aforementioned secure barcodes may likewise be imprinted. Further, it is understood that the card printer 22 has the capacity to emboss the surface of the card 12, as well as apply laminate topping. So that an aesthetically pleasing card 12 results, the card printer 22 has true over the edge printing.

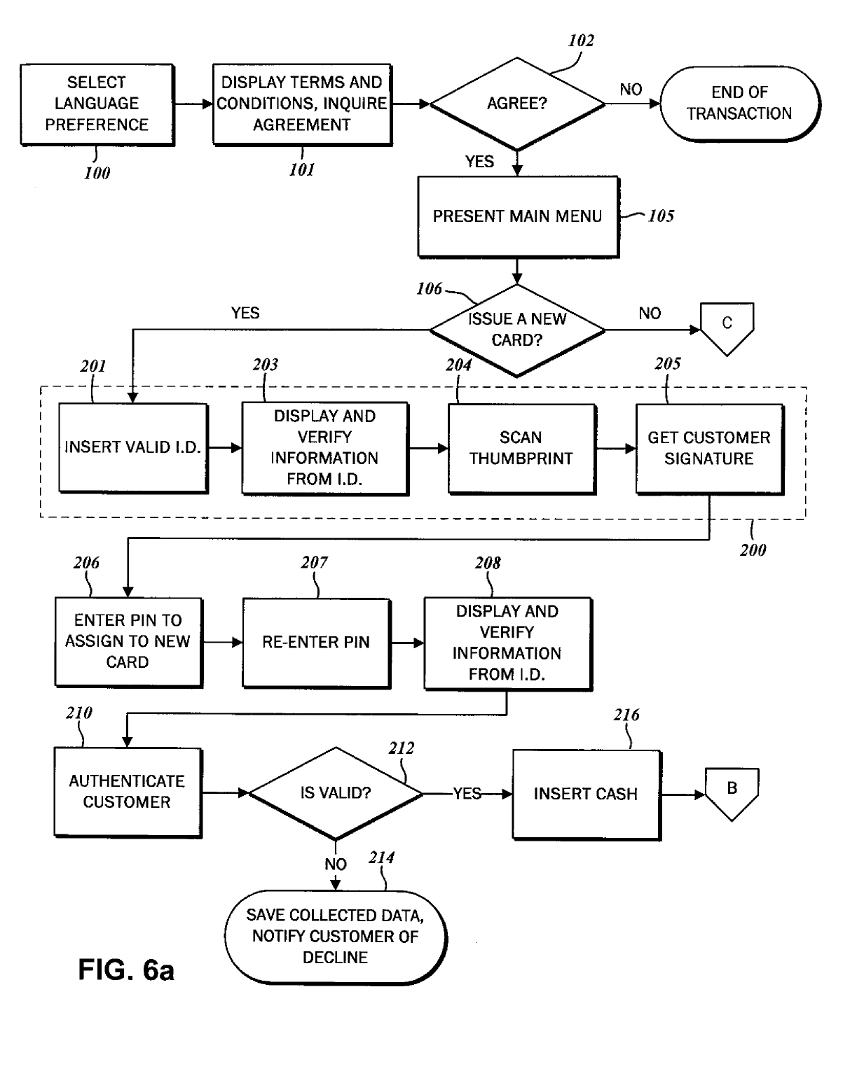

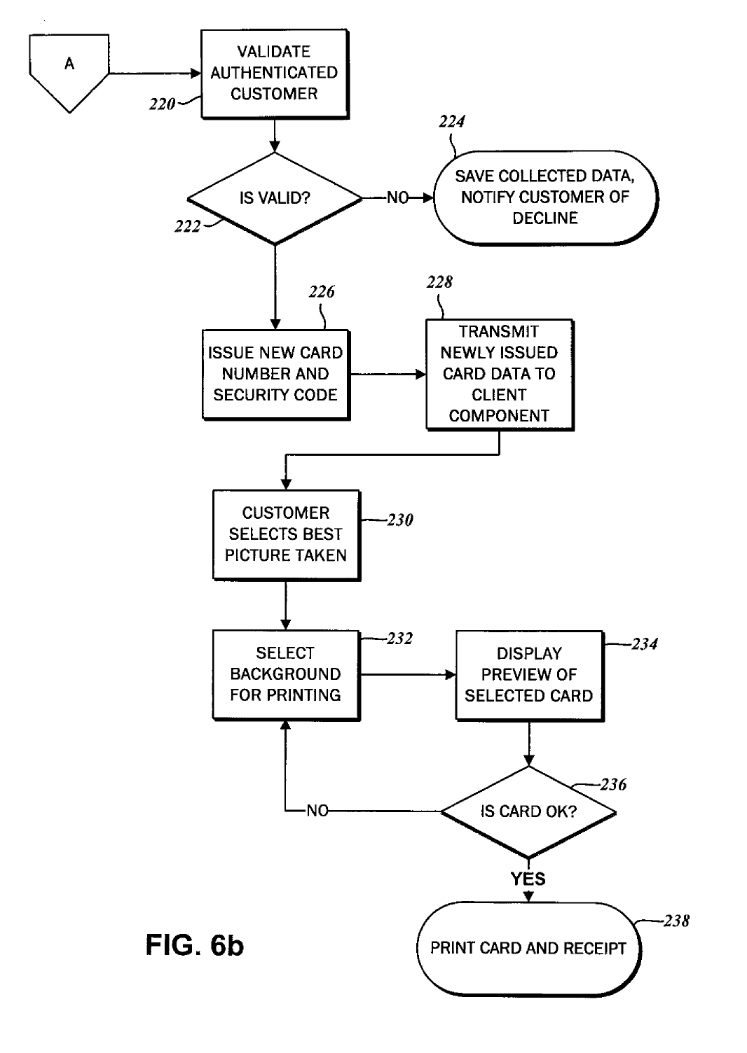

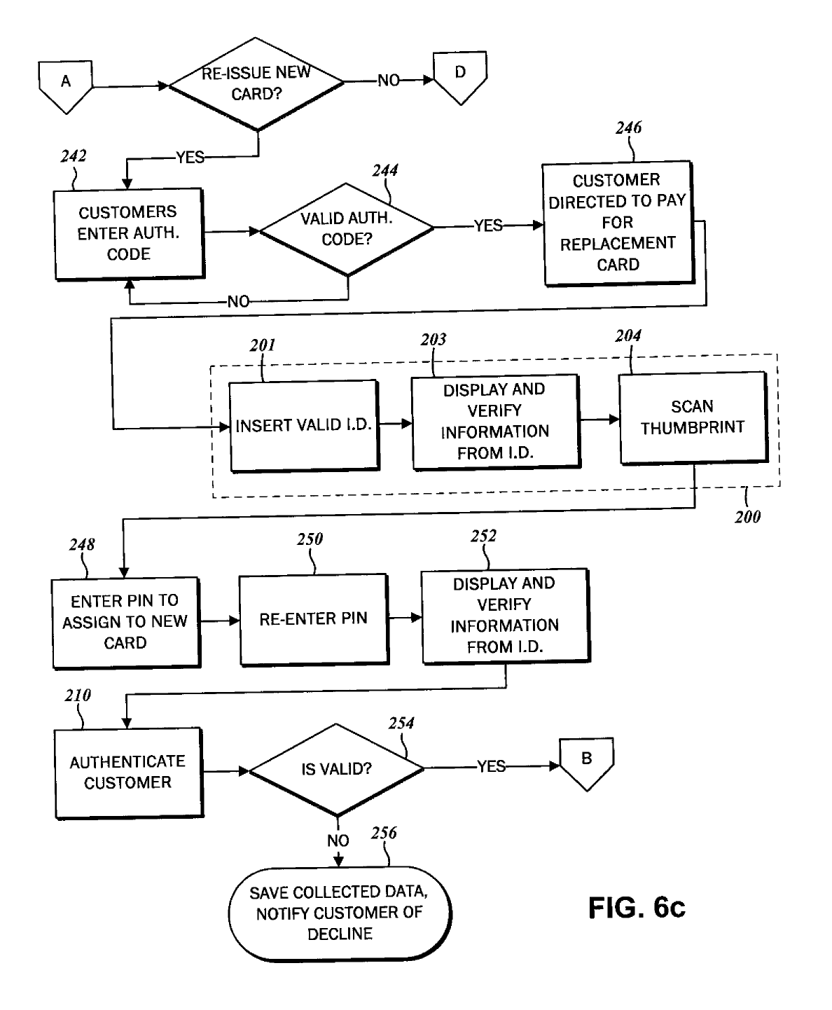

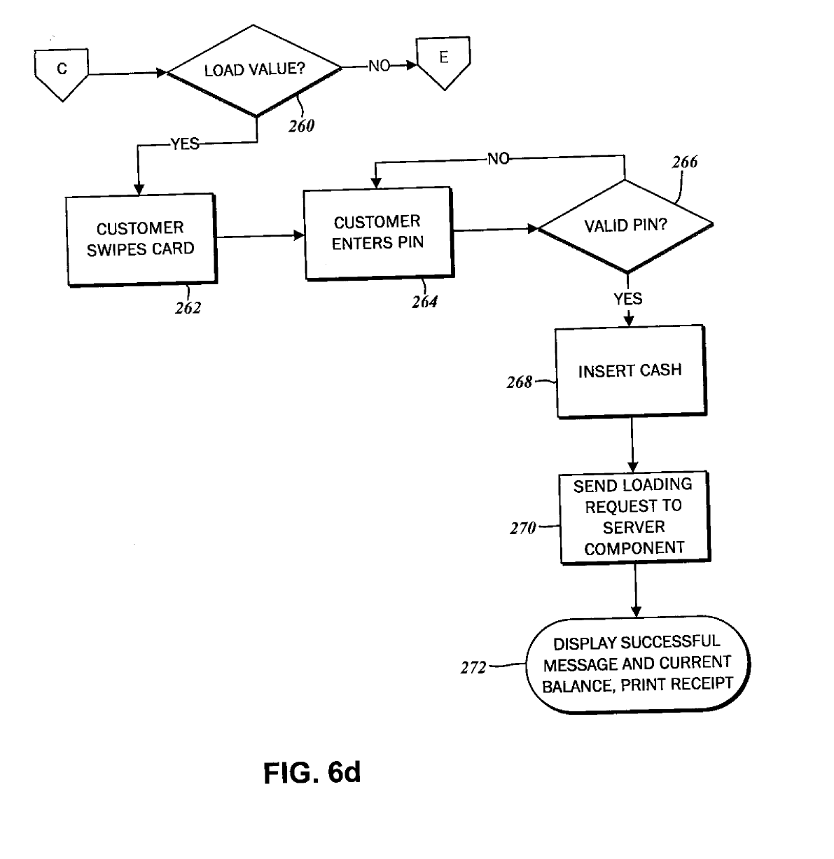

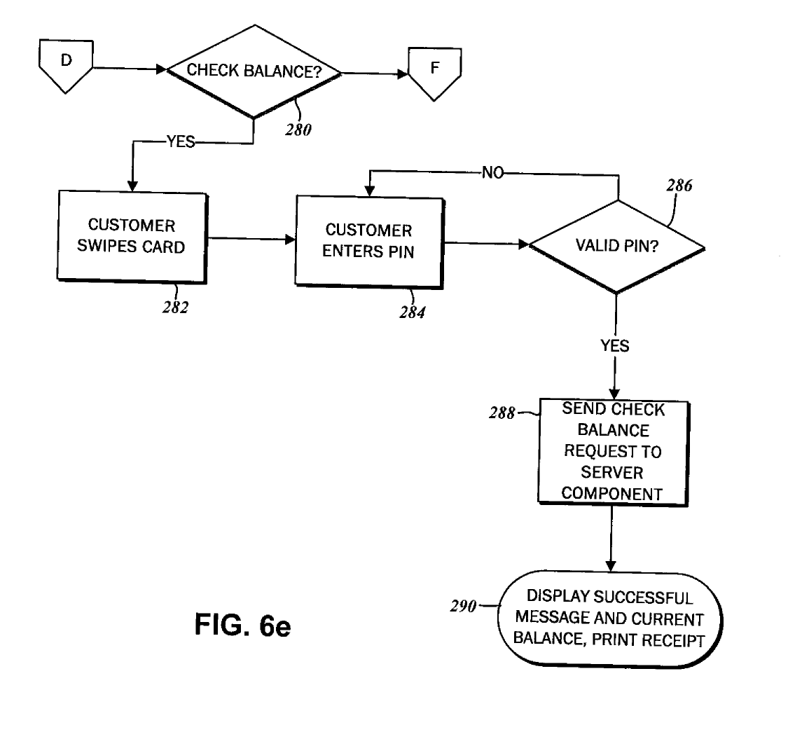

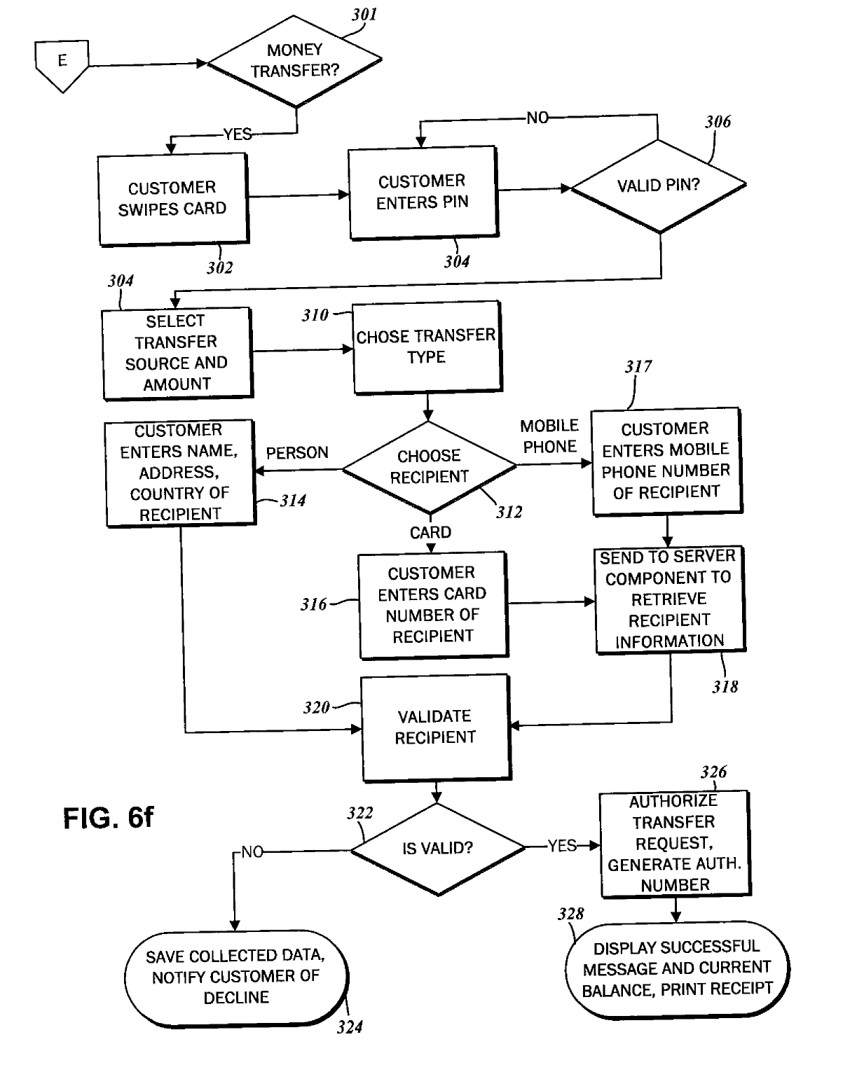

Having broadly considered the customization and instant authentication/verification/issuance aspects of the present invention, typically encountered specific usage examples of the card printing verification system 10 will now be described with reference to the flowcharts of FIGS. 6a-6f. The interaction with the client component 3 of the card printing verification system 10 begins with an initial step 100 of selecting a language preference for the subsequent prompts. It is understood that the available languages for selection are tailored to a specific region. Thereafter, in step 101, the customer is asked to agree to the terms and conditions of use. Before continuing, the customer is directed to enter a response. In comparison step 102, the customer's input is evaluated. If the customer enters a negative response, the transaction is terminated according to step 103. Otherwise, per step 105, the main menu is presented, and the prefatory steps are complete. According to one embodiment of the present invention, the main menu presents one of five options: issue a new card, re-issue a card, load an existing card, transfer money, and make a balance inquiry. Each of the sequences involved in these options will be described in turn below.

If the customer selects to issue a new card in decision branch 106, according to step 200, identification credentials are received from the customer. More specifically, this step further involves inserting an identification document into the ID card reader 28 per step 201. As explained above, the identification credential can be a drivers' license or any other document issued or approved by federal, state, county, local, or foreign governments, including passports The information stored on the identification document is retrieved, and then displayed on the touch screen device 34 according to step 203. At this time, the customer is also directed to verify the retrieved and displayed information. Provided that the customer desires to continue with the data read from the identification document, the customer is then directed to scan in a thumbprint according to step 204. In one embodiment of the present invention, the customer then provides a signature in step 205 via the signature pad 37, concluding step 200.

The customer is then asked to enter a PIN to be assigned to the newly issued card in step 206, and again in step 207 for verification purposes. In step 208, the PIN, the thumbprint, the captured signature, and the information retrieved from the identification document are transmitted to the server component 6 of the card printing verification system 10.

Thereafter, according to step 210 as previously described, the transmitted data is verified for authenticity and validated against a fraud detection database 46. If the customer is deemed authenticated or valid in decision branch 212 after a response from the identity verification module 14 is returned to the client component 3, the customer is directed to insert cash into the bill validator 38 in step 216. As indicated above, it is expressly contemplated that instead of cash, a check may be scanned for assigning value. Thus, the reference to “Insert Cash” in step 216 is understood to be equally applicable to providing a check for scanning and eventual verification and transfer of funds. Then, the sequence continues with step 220, shown in FIG. 6b. Otherwise, per step 214, the information retrieved from the identification document is saved for reporting purposes, and the customer is notified that the request for a new card has been declined. Additionally, an 800 number may be displayed for the customer to call to resolve any issues.

As also described above, once the customer is authenticated, the customer is validated with the compliance module 16 under step 220. Again, the compliance module 16 accesses the compliance database 48 to determine if the customer's identity matches any identity of prohibited persons. This evaluation is made in decision branch 222, and like step 214 above, if the identity matches that of a prohibited person, the customer is notified that the request has been denied according to step 224. If the customer is validated in decision branch 222, the card printing verification system 10, specifically the card issuance module 18 or a related external application associated with the server component 6, issues a new card number 52 and a corresponding verification code 62 according to step 226. The card issuance module 18 then transmits the newly issued data to the client component 3 of the card printing verification system 10 in step 228 for final customization and printing.

Thereafter, the sequence continues with step 230, in which pictures of the customer are taken and the best one is selected. In step 232, the customer selects various background options for the new card, and a preview of the selected one is displayed in step 234. If after the preview step 234 the customer is satisfied with the results and confirms the same in decision branch 236, the card printer 22 imprints the background, the customer picture, the card number 52, and the security number 64 onto a blank card according to step 238. The captured signature may also be printed on to the blank card. Additionally, the pertinent data is encoded on to the magnetic strip 62 or other electronic data storage device embedded within the card 12. A receipt may be produced by the receipt printer 44.

Returning to FIG. 6a, in decision branch 106, if the menu option for issuing a new card was not selected, the sequence continues with a decision branch 240 to evaluate whether to re-issue a new card. Typically, this would be necessary if the customer lost the card 12 and requires an immediate replacement. Thereupon, customer service may be contacted, which will provide the customer with an authorization code in step 242. If the authorization code is determined to be valid in decision branch 244, in step 246 the customer will be directed to make a payment to cover the costs of replacement. The payment of step 246 may be made from the existing account if there are sufficient funds; otherwise the customer inserts cash into the bill validator 38. If the authorization is determined not to be valid, then the customer is directed to enter it again. For the purposes of security, the number of tries allowed may be limited.

After payment is rendered, the sequence continues with step 200, including sub-steps 201, 203, and 204, which involve inserting an identification document into the ID card reader 28, retrieving and displaying the information stored in the identification document for confirmation, and scanning in a thumbprint, respectively.

The customer is then directed to enter a new PIN to assign to the new card 12 in step 248, and re-entered in step 250 for verification purposes. The information stored in the identification document is transmitted to the server component 6 of the card printing verification system 10, in accordance with step 252.

Thereafter, according to step 210 as previously described, the transmitted data is verified for authenticity and validated against a fraud detection database 46. If the customer is deemed authenticated or valid in decision branch 254 after a response from the identity verification module 14 is returned to the client component 3, the sequence continues with step 220, shown in FIG. 6b. Otherwise, per step 256, the information retrieved from the identification document is saved for reporting purposes, and the customer is notified that the request for a new card has been declined. Additionally, an 800 number may be displayed for the customer to call to resolve any issues.

If in the decision branch 240 the customer decided not to re-issue the card 12, the sequence continues into decision branch 260 shown in FIG. 6d, in which the sequence for loading money into the card 12 and its corresponding account is shown. If the customer selects the menu option to load a value, the sequence continues with the customer swiping the card 12 using the ID card reader 28 according to step 262. Next, in step 264, the customer is directed to enter the corresponding PIN via the secure keypad 36 in order to unlock access to the account. The validity of the PIN is determined in decision branch 266, and like other challenge-response security modalities, the number of access attempts is limited. Once the PIN has been determined to be valid, the customer inserts cash into the bill validator 38 according to step 268. As previously mentioned, it is understood that instead of cash provided to the bill validator 38, a check may be provided to the check reader 39 in step 268. Then, in step 270, the loading request is sent to the server component 6 of the card printing verification system 10. This sequence terminates at step 272, where the client component 3 displays a message indicating success, and the new balance on the card 12. Additionally, a receipt may be provided in accordance with such step.

With reference to FIG. 6e, the sequence continues with decision branch 280 if the customer did not select to load a value into the card 12. In this step, if the customer selected the option to check the remaining balance in the card 12, the customer is directed to swipe the card 12 with the ID card reader 28 in accordance with step 282. Then, the PIN is entered with the secure keypad 36 in step 284, and the validity of that entry is determined in decision branch 286. In step 288, the check balance request is sent to the server component 6 of the card printing verification system 10. This sequence terminates at step 290, where the client component 3 displays a message indicating success, and the current balance on the card 12. Additionally, a receipt may be provided.

The last of the five options available from the main menu is the transferring of money, with the sequence of steps therefor being shown in FIG. 6f. As with the checking of the balances and loading the value, the sequence begins with swiping the card 12 with the ID card reader 28 according to step 392, The PIN is entered with the secure keypad 36 according to step 304, and determined to be valid or not in decision branch 306.

According to one embodiment, the customer may insert cash into the bill validator 38, and transfer only the sum inserted. Alternatively, some or the entirety of the transfer may be withdrawn from the balance on the card 12. In either case, the customer selects how much to transfer from which source according to step 308.

Then, in step 310, the customer chooses the type of recipient of the transfer—either a person, a card, a bank account, or a mobile phone. The selection is evaluated in decision branch 312. If a person is selected, according to step 314, the customer enters the name, address, and country of the recipient. If card or preexisting account is selected, according to step 316 the customer enters the receiving card number so that additional details about the recipient can be retrieved in step 318. Similarly, if a mobile phone is selected, the customer enters the mobile phone number of the recipient in step 317. Thereafter, in step 318, the mobile phone number is used to retrieve additional details about the recipient.

Having retrieved additional details about the recipient, the sequence continues with step 320, which is the same as 220 in the other functions listed above, where the recipient is validated. Specifically, the compliance module accesses the compliance database to determine if the recipient's identity matches any identity of prohibited persons. This evaluation is made in decision branch 322, and if the identity matches that of a prohibited person, the customer is notified that the request to transfer has been denied according to step 324. If the recipient is validated in decision branch 322, the server component 6 of the card printing verification system 10, specifically the fund management module 20, transfers the finds to the specified recipient according to step 326 by generating a transfer authorization number. This is transmitted back to the client component 3, which displays a message indicating success, and print a receipt according to step 328. Based on the foregoing, it will be apparent to those having ordinary skill in the art that the type of recipient may be readily changed. For example, some embodiments of the present invention contemplate transfers to online accounts such as PayPal.

Still other embodiments contemplate transfers to participating utility companies and the like. With further particularity, the customer selects a biller to pay, such as a power company, a cable company, a gas company, and the like, and the amount to pay is specified. By default, the full amount due may be specified. Such a payment request may be transmitted to a specialized billing company that handles the transaction, with the proper amount of funds being deducted from the customer's account.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A method for verifying instant card issuance, comprising:
receiving from a user an identification credential including personally identifying data;
authenticating the user based upon an evaluation of the personally identifying data against a fraud detection database, the identity of the user being correlated to the identity specified in the identification credential;
validating the user based upon an evaluation of the personally identifying data against a compliance database including a list of prohibited identities, the user being designated as authorized upon authentication and validation; and
dispensing a transaction card linked via a unique identifier to a financial account associated with the authorized user, the transaction card being imprinted with the unique identifier and a custom user-selected design.

2. The method of claim 1, wherein the identification credential is a government-issued document with the personally identifying data being encoded thereon.

3. The method of claim 1, wherein the identification credential is a thumbprint of the user.

4. The method of claim 1, wherein prior to dispensing the transaction card, the method further includes:
capturing a plurality of facial images of the authorized user; and
imprinting a selected one of the facial images on to the transaction card, the selected one of the facial images being specified by the authorized user.

5. The method of claim 1, wherein prior to dispensing the transaction card, the method further includes:
displaying a plurality of predefined custom designs for the background of the transaction card; and
imprinting a selected one of the custom designs on to the transaction card, the selected one of the custom designs being specified by the authorized user.

6. The method of claim 1, further comprising:
encoded the unique identifier on to the transaction card.

7. The method of claim 6, wherein the transaction card includes a magnetic strip to which the unique identifier is encoded.

8. The method of claim 6, wherein the transaction card includes an integrated circuit chip to which the unique identifier is encoded.

9. The method of claim 1, further comprising:
receiving a personal identification number (PIN), the PIN restricting access to the financial account; and
encoding the PIN on to the card.

10. The method of claim 1, further comprising:
calculating a card verification identifier from the unique identifier and an expiration date thereof;
imprinting the card verification identifier on to the transaction card.

11. The method of claim 1, further comprising:
recording a transaction log entry for the authentication and validation of the user.

12. A method for verifying funds transfer from a financial transaction card, the method comprising:
receiving from a user locked account data for a transferor account stored on the financial transaction card and a corresponding personal identification number (PIN) for accessing the locked account data;
designating a transfer recipient whose identity is defined by recipient personal data;
validating the identity of transfer recipient based upon an evaluation of the recipient personal data against a compliance database including a list of prohibited identities; and
transferring the specified amount from the transferor account to a transferee account corresponding to the transfer recipient.

13. The method of claim 12, wherein the specified amount is withdrawn from an existing balance of the transferor account.

14. The method of claim 12, wherein prior to transferring the specified amount, the method further includes:
receiving from the user a fund deposit into the transferor account in an amount equivalent to the specified amount

15. The method of claim 12, wherein the transfer recipient is designated by a mobile phone number.

16. The method of claim 15, wherein the financial account is a mobile phone payment account.

17. The method of claim 12, wherein the transfer recipient is designated by values of the personal data inputted by the originating user.

18. The method of claim 17, wherein the user inputted values is an account identification number associated with the financial account of the transfer recipient.

19. The method of claim 12, further comprising:
recording a transaction log entry for the validation of the transfer recipient and the transfer of funds thereto, the log entry including an identity designation of the originating user.
